(19) United States
(12) Patent Application Publication
(10) Pub. No.: US 2014/0337583 A1
(43) Pub. Date: Nov. 13, 2014

(54) INTELLIGENT CACHE WINDOW MANAGEMENT FOR STORAGE SYSTEMS

(71) Applicant: LSI CORPORATION, San Jose, CA (US)

(72) Inventors: Kishore K. Sampathkumar, Bangalore (IN); Goutham SrinivasaMurthy, Bangalore (IN)

(73) Assignee: LSI CORPORATION, San Jose, CA (US)

(21) Appl. No.: 13/971,114

(22) Filed: Aug. 20, 2013

(30) Foreign Application Priority Data
May 7, 2013 (IN) 2043CHE2013

(51) Int. Cl. G06F 12/08

(52) U.S. Cl. CPC G06F 12/0802
USPC 711/141

(57) ABSTRACT

Methods and structure for intelligent cache window management are provided. The system comprises a memory and a cache manager. The memory stores entries of cache data for a logical volume. The cache manager is able to track usage of the logical volume by a host, and to identify logical block addresses of the logical volume to cache based on the tracked usage. The cache manager is further able to determine that one or more write operations are directed to the identified logical block addresses, to prevent caching for the identified logical block addresses until the write operations have completed, and to populate a new cache entry in the memory with data from the identified logical block addresses responsive to detecting completion of the write operations.

### CROSS REFERENCE TO RELATED APPLICATIONS

This document claims priority to Indian Patent Application Number 2043/CHE/2013 filed on May 7, 2013 (entitled INTELLIGENT CACHE WINDOW MANAGEMENT FOR STORAGE SYSTEMS) which is hereby incorporated by reference.

### FIELD OF THE INVENTION

The invention relates generally to storage systems, and more specifically to cache memories implemented by storage systems.

### BACKGROUND

In storage systems, data for a host is maintained on one or more storage devices (e.g., spinning disk hard drives) for safekeeping and retrieval. However, the storage devices may have latency or throughput issues that increase the amount of time that it takes to retrieve data for the host. Thus, many storage systems include one or more cache devices for storing “hot” data that is regularly accessed by the host. The cache devices can retrieve data much faster than the storage devices, but have a smaller capacity. Tracking data for the cache devices indicates what data is currently cached, and can also indicate where cached data is found on each cache device. Cache data is stored in one or more cache entries on the cache devices, and over time old cache entries can be replaced with new cache entries that store different data for the storage system.

### SUMMARY

Systems and methods herein provide for intelligent allocation of cache entries in a storage system. If data for a new cache entry is about to be altered by an incoming write operation, the system can wait to populate the cache entry with data until the write operation has completed.

One exemplary embodiment is a system that comprises a memory and a cache manager. The memory stores entries of cache data for a logical volume. The cache manager is able to track usage of the logical volume by a host. The cache manager is also able to identify logical block addresses of the logical volume to cache, based on the tracked usage. The cache manager is further able to determine that one or more write operations are directed to the identified logical block addresses, to prevent caching for the identified logical block addresses until the write operations have completed, and to populate a new cache entry in the memory with data from the identified logical block addresses responsive to detecting completion of the write operations.

Other exemplary embodiments (e.g., methods and computer readable media relating to the foregoing embodiments) are also described below.

### BRIEF DESCRIPTION OF THE FIGURES

Some embodiments of the present invention are now described, by way of example only, and with reference to the accompanying figures. The same reference number represents the same element or the same type of element on all figures.

FIG. 1 is a block diagram of an exemplary storage system.

FIG. 2 is a flowchart describing an exemplary method for operating a storage system.

FIG. 3 is a block diagram of an exemplary cache window.

FIG. 4 is a block diagram of an exemplary set of tracking data for a cache memory.

FIG. 5 is a block diagram of an exemplary cache window that has been generated based on the tracking data of FIG. 4.

FIG. 6 is a block diagram of an exemplary read-fill operation that populates the cache window of FIG. 5.

FIG. 7 is a block diagram of an exemplary write operation that interrupts the read-fill operation of FIG. 6.

FIG. 8 is a block diagram of an exemplary completion of the read-fill operation of FIG. 6.

FIGS. 9-10 are flowcharts describing exemplary methods for cache window management.

FIG. 11 illustrates an exemplary processing system operable to execute programmed instructions embodied on a computer readable medium.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

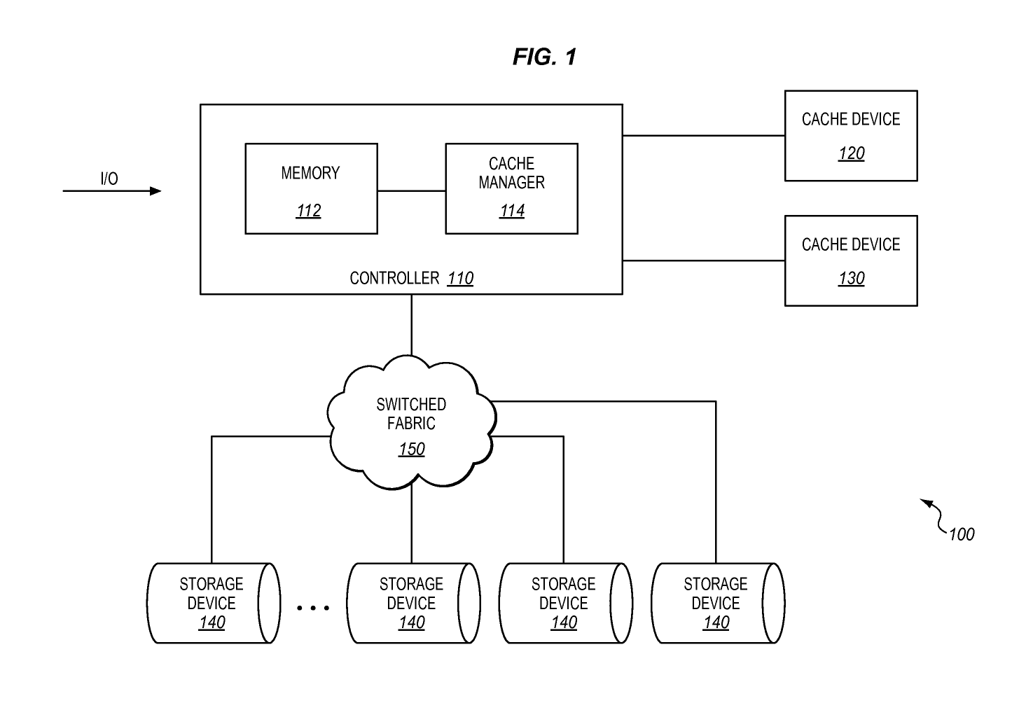

FIG. 1 is a block diagram of an exemplary storage system 100. Storage system 100 creates entries in cache memory that can be retrieved and provided to a host. Each entry stores data from a logical volume. The cache entries can be accessed more quickly than the persistent storage found on storage devices 140. Therefore, if the host regularly accesses known sets of data from the logical volume, the data can be cached for faster retrieval.

In this embodiment, storage system 100 includes controller 110, which maintains data at one or more persistent storage devices 140 (e.g., magnetic hard disks) on behalf of a host. In one embodiment, controller 110 is a storage controller, such as a Host Bus Adapter (HBA) that receives Input/Output (I/O) operations from the host and translates the I/O operations into commands for storage devices in a Redundant Array of Independent Disks (RAID) configuration.

In embodiments where controller 110 is independent from the host, controller 110 manages I/O from the host and distributes the I/O to storage devices 140. Controller 110 communicates with storage devices 140 via switched fabric 150. Storage devices 140 implement the persistent storage capacity of storage system 100, and are capable of writing and/or reading data in a computer readable format. For example, storage devices 140 may comprise magnetic hard disks, solid state drives, optical media, etc. compliant with protocols for SAS, Serial Advanced Technology Attachment (SATA), Fibre Channel, etc.

Storage devices 140 implement storage space for one or more logical volumes. A logical volume comprises allocated storage space and data available at storage system 100. A logical volume can be implemented on any number of storage devices 140 as a matter of design choice. Furthermore, storage devices 140 need not be dedicated to only one logical volume, but may also store data for a number of other logical volumes. In one embodiment, a logical volume is configured as a Redundant Array of Independent Disks (RAID) volume in order to enhance the performance and/or reliability of stored data.

Switched fabric 150 is used to communicate with storage devices 140. Switched fabric 150 comprises any suitable combination of communication channels operable to forward/route communications for storage system 100, for example, according to protocols for one or more of Small Computer System Interface (SCSI), Serial Attached SCSI (SAS), FibreChannel, Ethernet, Internet SCSI (ISCSI), etc. In one embodiment, switched fabric 150 comprises a combination of SAS expanders that link to one or more SAS/SATA targets (e.g., storage devices 140).

Controller 110 is also capable of managing cache devices 120 and 130 in order to maintain a write-through cache for servicing read requests from the host. For example, cache devices 120 and 130 may comprise Non-Volatile Random Access Memory (NVRAM), flash memory, or other devices that exhibit substantial throughput and low latency.

Cache manager 114 maintains tracking data for each cache device in memory 112. In one embodiment, the tracking data indicates which Logical Block Addresses (LBAs) for a logical volume are duplicated to cache memory from persistent storage at storage devices 140. If an incoming read request is directed to a cached LBA, cache manager 114 directs the request to the appropriate cache device (instead of one of persistent storage devices 140) in order to retrieve the data more quickly. Cache manager 114 may be implemented as custom circuitry, as a processor executing programmed instructions stored in program memory, or some combination thereof.

The particular arrangement, number, and configuration of components described herein is exemplary and non-limiting. While in operation, cache manager 114 is able to update the tracking data stored in memory 112, to update cache data stored on each cache device, and to perform various management tasks such as invalidating cache data, rebuilding cache data, and revising cache data based on the I/O operations from the host. For example, storage system 100 is operable to update the cache with new data that is “hot” (i.e., regularly accessed by the host).

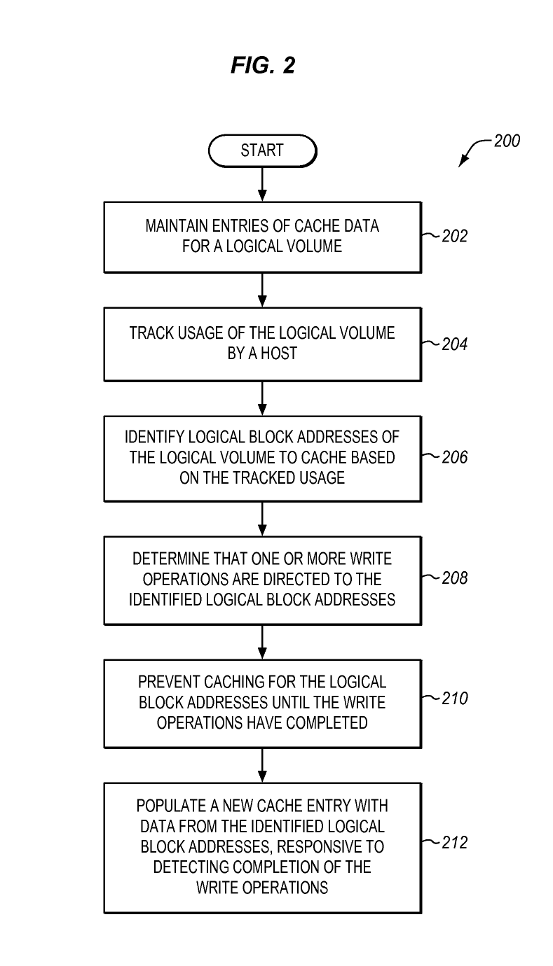

In one embodiment controller 110 maintains a list of cache misses for LBAs of the logical volume. A cache miss occurs whenever a read request is directed to data that is not stored within the cache. If an LBA has recently encountered a large number of cache misses, controller 110 can create a new cache entry to hold the “hot” data for the LBA. Further details of the operation of storage system 100 will be described with respect to method 200 of FIG. 2 below.

FIG. 2 is a flowchart describing an exemplary method 200 for operating a storage system. Assume, for this embodiment, that storage system 100 is operating to update and revise cache data, based upon the data in a logical volume that is currently “hot.”

In step 202, cache manager 114 maintains entries of cache data for the logical volume. Each cache entry stores data from a range of one or more LBAs on the logical volume. When the host attempts to read cached data, it can be read from cache devices 120 and/or 130 instead of persistent storage devices 140. This saves time at the host, resulting in increased performance.

In step 204, cache manager 114 tracks usage of the logical volume by the host. In one embodiment, cache manager 114 tracks usage by determining which LBAs of the logical volume have been subject to a large number of cache misses over a period of time.

In step 206, cache manager 114 identifies one or more LBAs of the logical volume to cache, based on the tracked usage. In one embodiment, the LBAs are identified based on the number of cache misses they have experienced in comparison to other un-cached LBAs. For example, if an LBA (or range of LBAs) has experienced a large number of cache misses, and/or if the LBA has been “missed” more often than an existing cache entry has been accessed, cache manager 114 can generate a new cache entry to store data for the LBA.

Once LBAs have been identified for caching, cache manager 114 may start to populate a cache entry with data from the identified LBAs. As a part of this process, cache manager 114 can start to copy data for the LBAs from storage devices 140 to cache devices 120 and/or 130.

In step 208, cache manager 114 determines that one or more write operations are directed to the LBAs for the new cache entry. This can occur prior to or even after cache manager 114 starts to populate the new cache entry with persistently stored data. If a write operation is directed to the same LBAs as the new cache entry, it will invalidate the data in the new cache entry.

After an incoming write has been detected, in step 210 cache manager 114 prevents caching for the identified LBAs until the write operations have completed. If cache manager 114 continued to populate the cache entry with data while the write operation was in progress, the cache data would be invalidated when the write operation completed (because the write operation would make all of the cache data out-of-date). Thus, the cache entry would need to be re-populated with cache data from persistent storage. To prevent this result, cache manager 114 halts caching for the new cache entry until the overlapping write operations are completed.

In a further embodiment, cache manager 114 may halt caching for specific portions of cache data that would be invalidated, instead of halting caching for the entire cache entry. For example, if each cache entry is a cache window, cache manager 114 can halt caching for individual cache lines of the cache window that would be overwritten, or can halt caching for entire cache windows. While the caching is halted, incoming reads directed to the LBAs for the cache entry may bypass the cache, and instead proceed directly to persistent storage at storage devices 140.

In step 212, cache manager 114 populates the new cache entry with data from the identified logical block addresses, responsive to detecting completion of the write operations. Thus, the cache data accurately reflects the data kept in persistent storage for the volume.

Even though the steps of method 200 are described with reference to storage system 100 of FIG. 1, method 200 may be performed in other systems. The steps of the flowcharts described herein are not all inclusive and may include other steps not shown. The steps described herein may also be performed in an alternative order.

### EXAMPLES

In the following examples, additional processes, systems, and methods are described in the context of a storage system that implements advanced caching techniques. Specifically, the following examples illustrate efficient methods that eliminate serialization of I/O requests for which either new cache entries are not yet allocated, or are in the process of being allocated. In one example, a reactive method coordinates on the outstanding writes and ensures the data consistency of the cache lines involved for any overlapping reads. In another example, a proactive method ensures that any read request issued on an outstanding overlapping write is delayed just until the completion of the write request. The methods can detect and handle different levels of granularity for I/O requests that overlap cache data.

In these examples, each cache device is logically divided into a number of cache windows (e.g., 1 MB cache windows). Each cache window includes multiple cache lines (e.g., 16 individual 64 KB cache lines). For each cache window, the validity of each cache line is tracked with a bitmap. If data in a cache line is invalid, the cache line no longer accurately reflects data maintained in persistent storage. Therefore, invalid cache lines are not used until after they are rebuilt with fresh data from the storage devices of the system.

In one embodiment, if a write is directed to LBAs for one or more cache lines within a cache window, cache manager 114 invalidates only the cache lines that store data for those LBAs, instead of invalidating an entire cache window.

If a cache window includes any valid cache lines, it is marked as active. However, if a cache window does not include any valid cache lines, it is marked as free. Active cache windows are linked to a hash list. The hash list is used to correlate Logical Block Addresses (LBAs) requested by a host with active cache windows residing on one or more cache devices. In contrast to active cache windows, free cache windows remain empty and inactive until they are filled with new, “hot” data for new LBAs. One metric for invalidating cache lines and freeing up more space in the cache is maintaining a Least Recently Used (LRU) list for the cache windows. If a cache window is at the bottom of the LRU list (i.e., if it was accessed the longest time ago of any cache window), it may be invalidated to free up more space when the cache is full. An LRU list may track accesses on a line-by-line, or window-by-window basis.

To determine what data to write to newly available free cache windows, cache manager 114 maintains a list of cache misses in memory. A cache miss occurs when the host requests data that is not stored in the cache. If a certain LBA (or range of LBAs) is associated with a large number of cache misses, the data for that LBA may be added to one or more free cache windows.

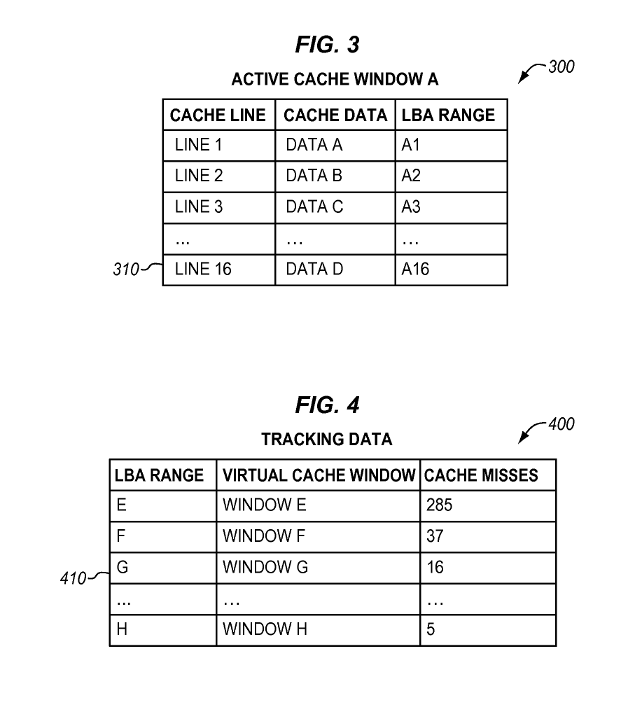

In one embodiment, cache misses are tracked for virtual cache windows. A virtual cache window is a range of contiguous LBAs that can fill up a single active cache window. However, a virtual cache window does not store data for the logical volume. Instead, the virtual cache window is used to track the number of cache misses (e.g., over time) for its range of LBAs. If a large number of cache misses occur for the range of LBAs, the virtual cache window may be converted to an active (aka “physical”) cache window, and data from the range of LBAs may then be cached for faster retrieval by a host. Specific embodiments of cache windows are shown in FIG. 3, discussed below.

FIG. 3 is a block diagram 300 of an exemplary cache window 310. In this embodiment, cache window 310 includes multiple cache lines, and each cache line includes cache data as well as a tag. The tag identifies the LBAs in persistent storage represented by the cache line.

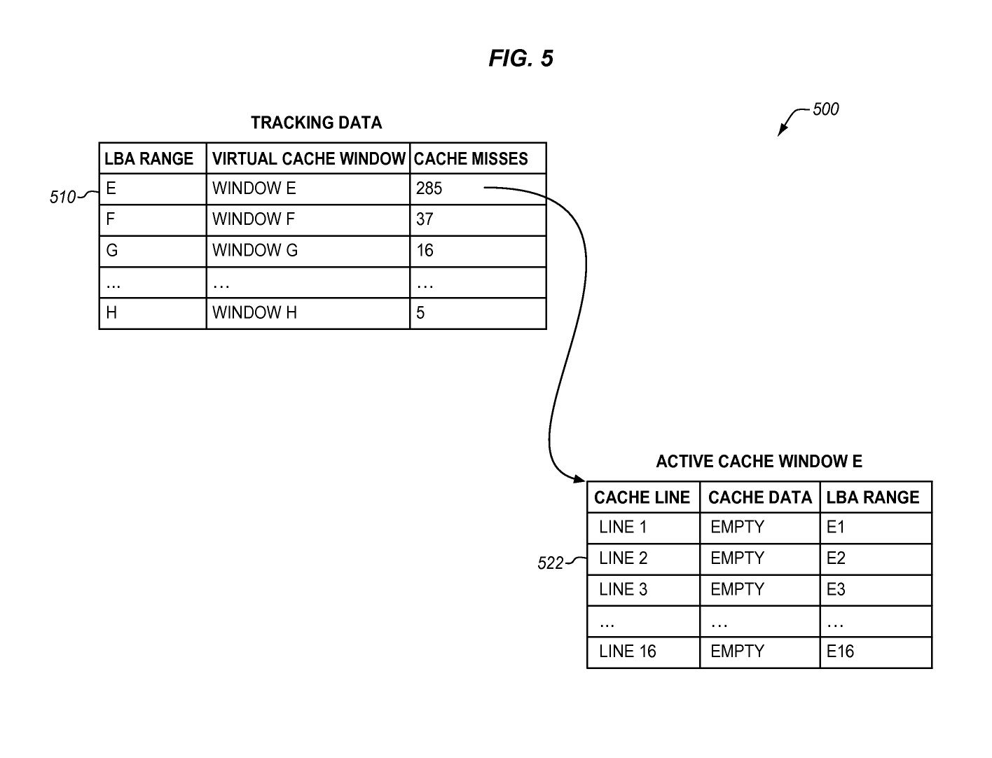

FIG. 4 is a block diagram 400 of an exemplary set of tracking data for a cache memory. According to FIG. 4, each entry 410 in the tracking data describes the number of cache misses for a virtual cache window. As discussed above, a virtual cache window does not presently store cache data. Instead, a virtual cache window represents a range of LBAs. This range of LBAs is a candidate to populate the next free cache window (when it becomes available).

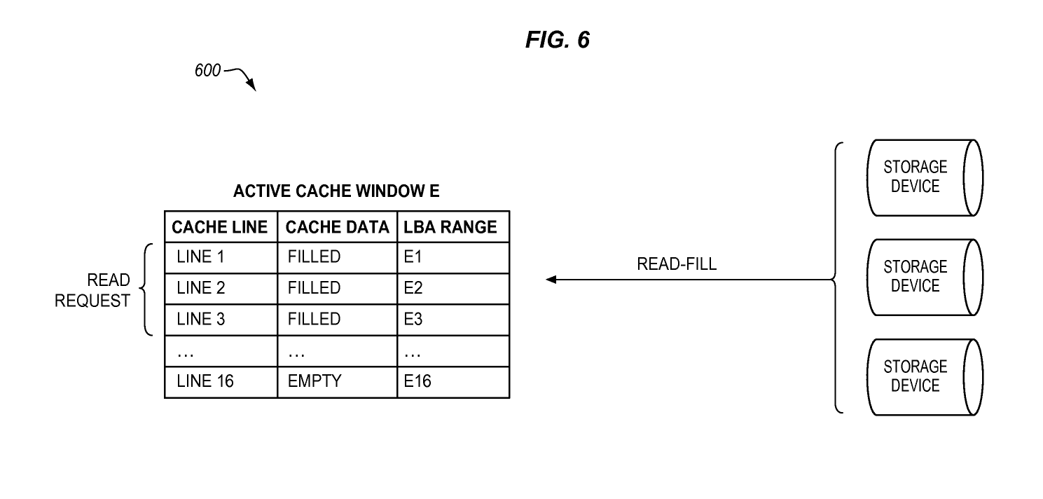

FIG. 5 is a block diagram 500 of an exemplary cache window that has been generated based on the tracking data of FIG. 4. According to FIG. 5, entry 510 in tracking data indicates that an LBA range E, associated with virtual cache window E, has experienced a larger number of cache misses than other virtual cache windows. Therefore, cache manager 114 decides to transform virtual cache window E into an active cache window.

As part of this process, cache manager 114 updates memory 112 to list cache window E as an active window. Cache manager 114 also allocates free space on cache devices 120 and/or 130 in order to store data for active cache window E. For example, cache line 522 for cache window E represents a physical location available to store data for the LBA range “E1” (which is a portion of the overall LBA range “E”).

### Reactive Cache Line Invalidation Example

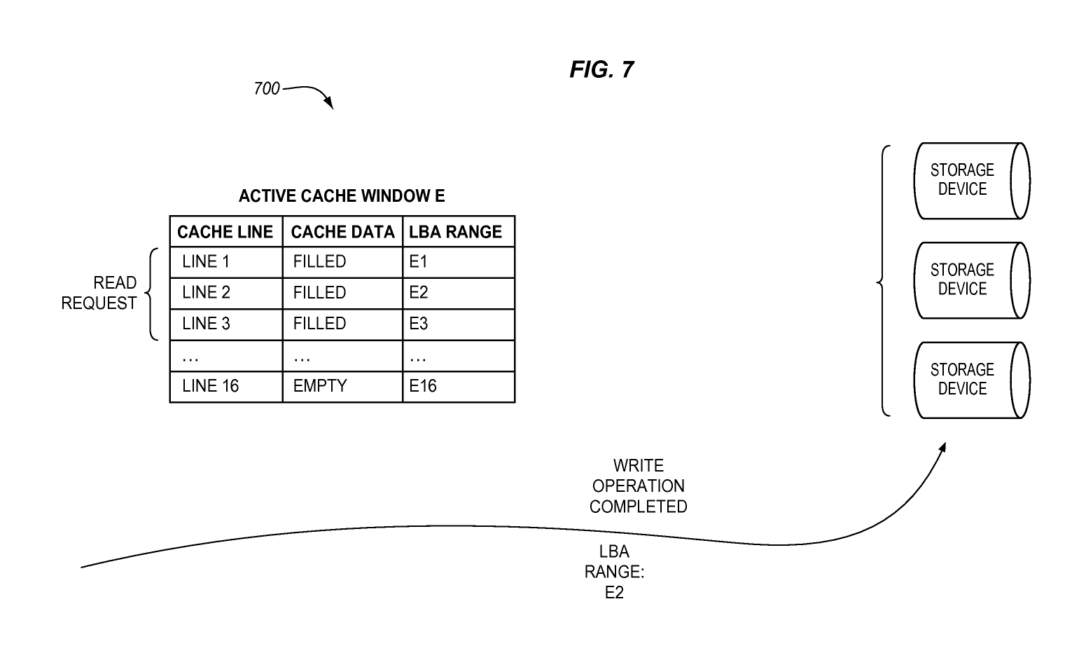

In a reactive process for cache line invalidation, corresponding to a write request received for a virtual cache window and issued to the persistent storage on storage devices 140, the cache manager determines at the time of write completion processing whether the outstanding write request also refers to a block range kept at a physical cache window that is currently undergoing a read-fill operation. If so, only the cache lines involved in the block range for the write request are invalidated at the physical cache window (thus, the entire read-fill operation is not invalidated). Further details are described with regard to FIGS. 6-8 as discussed below.

In this example, once cache window E of FIG. 5 has been made into a physical cache window, as part of completing I/O requests that were issued (on the virtual cache window) before the physical cache window is created, cache manager 114 detects an outstanding I/O read-fill operation directed to the LBAs of cache window E. Cache manager 114 then waits for the outstanding read-fill operation to complete. Until such time, write request completion is put on hold. Once the read-fill operation is complete, the write completion processing resumes. As part of this, the cache lines involved in the write are invalidated, while the non-overlapping cache lines populated by the I/O read-fill operation are left untouched. The non-overlapping cache lines continue to remain valid.

FIG. 6 is a block diagram 600 of an exemplary read-fill operation that populates the cache window of FIG. 5. According to FIG. 6, when the read-fill operation is performed, the data for cache window E is not populated to cache memory until an incoming read operation from a host is directed to the cache window. The requested data is then retrieved from persistent storage on storage devices 140 and copied to cache memory on cache devices 120 and/or 130. In this embodiment, the read-fill is performed on a line-by-line basis for cache window E.

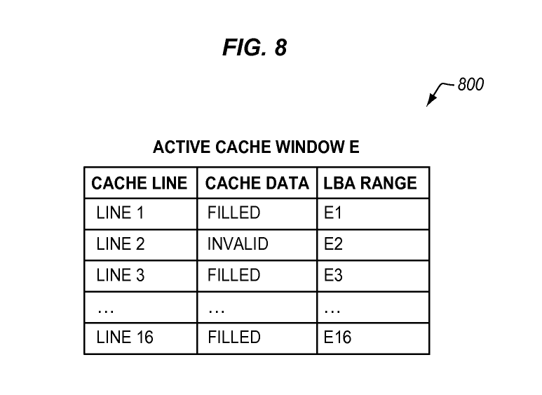

FIG. 7 is a block diagram 700 of an exemplary outstanding write operation on LBA range E2 that completes while the read-fill operation of FIG. 6 is in progress. In this case, the write completion arrives when the read-fill operation has completed populating cache lines 1 through 3 with data, but has not yet added cache data to the other cache lines.

Because the outstanding write operation directly modified the contents of the backend persistent storage for the LBAs in cache line E2 for cache window E, the cache line E2 of cache window E will be invalidated after the read fill is completed. To address this issue, cache manager 114 puts the write completion on hold until it completes the read fill request. Once the read-fill operation is complete, the write completion processing resumes. As part of processing write completion, just the cache line E2 involved in the write is invalidated. The non-overlapping cache lines E1 and E3-E16 populated by the I/O read-fill operation are left untouched, and continue to remain valid.

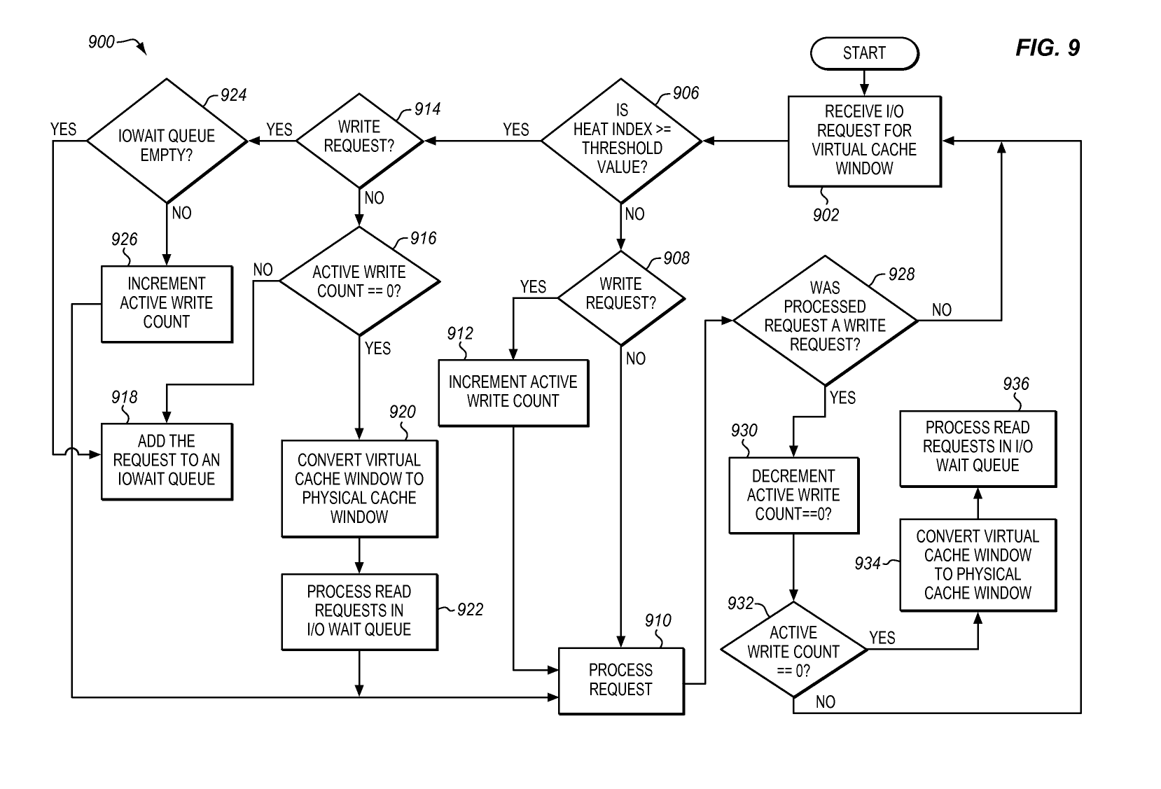

FIG. 8 is a block diagram 800 of an exemplary completion of the read-fill operation of FIG. 6. According to FIG. 8, once the read-fill operation completes, the write operation invalidates cache line E2,

### Proactive Cache Line Invalidation Example

In an embodiment implementing proactive cache line invalidation, cache manager 114 tracks a number/count of outstanding/pending writes, called an “Active Write” count for each virtual cache window (e.g., by incrementing or decrementing the Active Write count as new writes are received or completed, respectively). As long as the Active Write count is non-zero, the virtual window will not be converted to a physical window. In this embodiment, the Active Write counts are used for virtual cache windows and are not used for physical cache windows.

In this example, I/O request processing is performed based on a “heat index” associated with each virtual cache window. This heat index can indicate the number of read cache misses for a virtual cache window; the number of read cache misses for a virtual cache window over a period of time, etc. Then, based on the heat index and the nature of a request received, a course of action for the request can be selected. In a Write Through cache mode, writes do not contribute to this heat index.

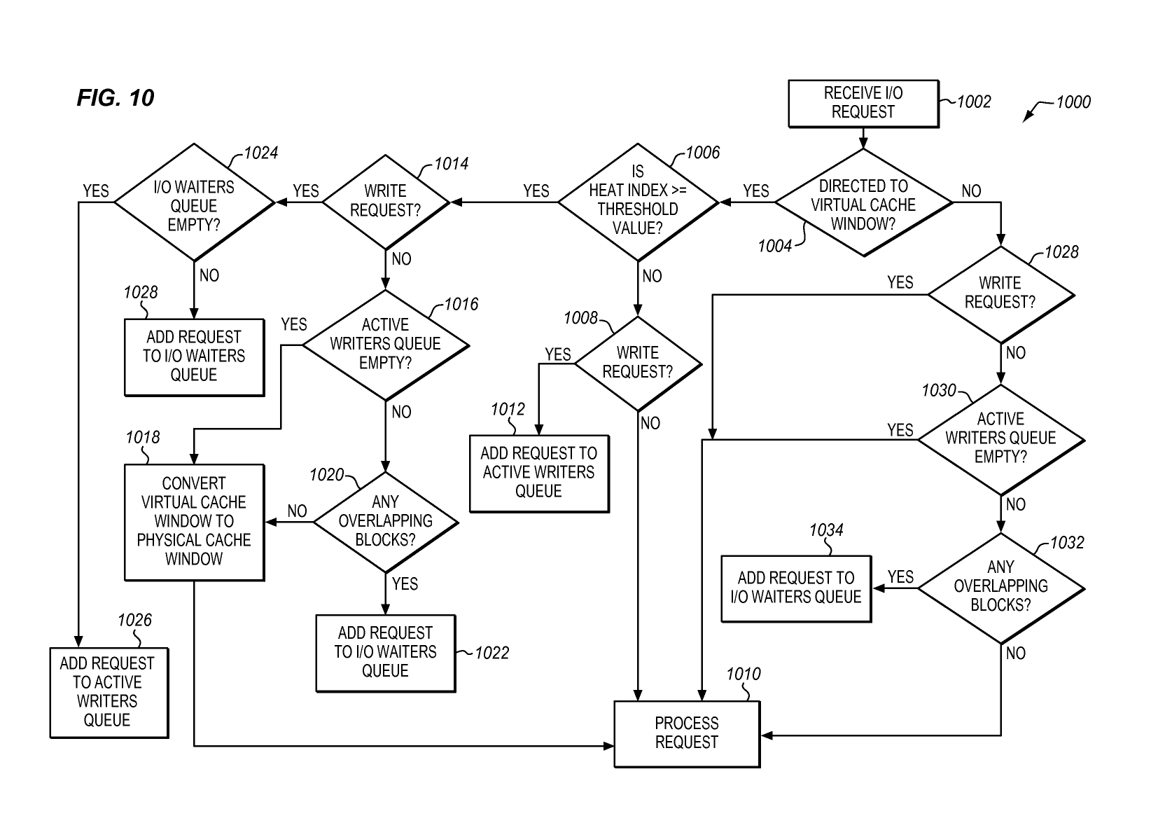

In this method 900 as shown in FIG. 9, if a received I/O request (step 902) is directed to a virtual cache window with a heat index below a predefined threshold (step 906), the I/O request is analyzed by the cache manager to determine whether it is a write request or a read request (step 908). If the I/O request is a write request, then the Active Write count is incremented for this virtual cache window (step 912). Following this, a common I/O processing is done both for read and write where the I/O request is issued as a by-pass I/O operation and processed (step 910).

In Write Through cache mode, a virtual cache window can be converted to a physical window only during a read operation. If the received I/O request is determined to be a read request directed to a virtual cache window with a heat index equal to or above the predefined threshold (step 914), then the cache manager determines if any write requests are Active (step 916). This is checked by determining the value of the “Active Write” count whose details were covered earlier. If the Active Write count is non-zero, the Read Request will be queued into a newly introduced “iowait queue” in the Virtual Cache window (step 918). If the Active Write count is zero, it indicates that there are no write requests left to complete for this virtual cache window. Thus, the virtual cache window is converted to a physical cache window (step 920). All the I/O requests queued on “iowait queue” are re-issued (step 922). The read request is then processed after or during the process of Virtual to physical cache window conversion (step 910).

If the received I/O request is determined to be a write request directed to a virtual cache window with a heat index equal to or above the predefined threshold (step 914), the “iowait queue” is first checked (step 924). If it is non-empty, then, the write request is queued into the “iowait queue” in the virtual cache window (step 918). However, if it is empty, then the Active Write count is incremented for this virtual cache window (step 926). Following this, the write is issued as a by-pass I/O operation and processed (step 910).

On completion of Write request (step 928) on a Virtual Cache window, the “Active Write count” is decremented (step 930). If this write request is the last active write I/O on this virtual cache window (Active Write count is zero), and if there are I/O's queued on the Virtual CW “iowait queue,” then the following process is performed.

The virtual cache window is converted into a physical cache window (step 932). The first I/O request queued on the “iowait queue” is dequeued and processed. This is guaranteed to be a read request. The rest of the I/O requests in the “iowait queue” for the virtual cache window are de-queued and re-issued on the physical cache window (step 934).

### Refined Proactive Cache Line Invalidation Example

In the following detailed example, additional processes, systems, and methods are described in the context of intelligent cache window management systems. Assume for this example that there are two additional queues that are maintained for each virtual cache window and each physical cache window. The first queue is referred to as an “Active Writers” queue, and the second queue is referred to as an “I/O Waiters” queue.

In general in this example, when I/O requests are processed by the cache manager, whenever a write request is received for a virtual cache window, the cache manager adds an entry to an Active Writers queue for that virtual cache window (e.g., to a tail end of the queue, or in a sorted position based on the starting LBA that the write request is directed to). Write requests received after the virtual cache window has been converted to a physical cache window are not added to an Active Writers queue. FIG. 10 is a flowchart describing this exemplary method 1000 for cache window management.

In this example, I/O request processing is performed based on a “heat index” associated with each virtual cache window. This heat index can indicate the number of cache misses for a virtual cache window, the number of cache misses for a virtual cache window over a period of time, etc. Then, based on the heat index and the nature of a request received (step 1002), a course of action for the request can be selected.

In this system, if a received I/O request is directed to a virtual cache window (step 1004) with a heat index below a predefined threshold (step 1006), the I/O request is analyzed by the cache manager to determine whether it is a write request or a read request (step 1008). If the I/O request is a read request, it is issued as a by-pass I/O operation and processed (step 1010). However, if the I/O request is a write request, then an entry for the write request is added to the Active Writers queue for this virtual cache window (step 1012).

Alternatively, if the received I/O request is determined to be a read request directed to a virtual cache window with a heat index equal to or above the predefined threshold (step 1014), then the cache manager determines if any write requests in the Active Writers queue for this virtual cache window have yet to be completed (step 1016). If the Active Writers queue indicates that there are no write requests left to complete for this virtual cache window (i.e., if the Active Writers queue is empty), then the virtual cache window is converted to a physical cache window as discussed below (step 1018). The read request is then processed after or during this conversion process (step 1010). If the Active Writers queue is not empty, then the cache manager checks to determine whether the block range of any write requests in the queue overlap any of the blocks in the read request (step 1020). If there are overlapping blocks, then the cache manager adds an entry for the read request to the I/O Waiters queue for this cache window (e.g., at the end of the I/O Waiters queue) (step 1022). If there are no overlapping blocks, then the virtual cache window is converted to a physical cache window as discussed below (step 1018). The read request is then processed after or during this conversion process (step 1010).

Alternatively, if the received I/O request is determined to be a write request directed to a virtual cache window with a heat index equal to or above the predefined threshold (step 1014), then the cache manager determines whether the I/O Waiters queue is empty (step 1024). If the I/O Waiters queue is empty, then the write request is made active by adding the write request to the Active Writers queue for this cache window (e.g., at the tail of the queue) (step 1026), and the write request is eventually processed based on its position in the queue. However, if the I/O Waiters queue is not empty, then the write request is added to the end of the I/O Waiters queue and processed based on its queue position (step 1028). This ensures that an incoming write request will not overwrite data requested by a previously received read request.

Alternatively, if the received I/O request is determined to be a read request directed to a physical cache window (e.g., a “real” cache window and not a tracking structure) (step 1028), then the cache manager reviews the Active Writers queue to determine whether it is empty (step 1030). If the Active Writers queue is empty, then the read request is processed so that data is retrieved from the cache window and provided to the host (step 1010). However, if the Active Writers queue is not empty, the cache manager checks the block range of the read request to determine whether it overlaps with any write requests in the Active Writers queue (step 1032). If there is an overlap, then the cache manager adds the read request to the I/O Waiters queue (e.g., at the tail end of the I/O Waiters queue) (step 1034). If there is no overlap, then the read request is processed in the usual fashion so that data is retrieved from the cache window and provided to the host (step 1010).

Alternatively, if the received I/O request is determined to be a write request directed to a physical cache window (e.g., a “real” cache window and not a tracking structure) (step 1028), then the write request is processed as a standard write request directed to a cache window (step 1010).

In this example, whenever a virtual cache window is converted to a physical cache window, the following steps are taken: the virtual cache window is removed from an “Active Hash” list, a physical cache window is allocated and inserted into the Active Hash list, pointer values for the virtual cache window (e.g., for the Active Writers queue and I/O Waiters queue) are copied to the physical cache window, and the virtual cache window is freed.

In this example, processing after a write request for a virtual cache window has completed is performed in the following manner: the entry for the write request is removed from the Active Writers queue. Then, if the I/O Waiters queue is not empty, the head I/O request at the front of the I/O Waiters queue is reviewed. This is guaranteed to be a Read request. If the I/O range of this head I/O read request overlaps with the write request that just completed, and there are also no other I/O requests on the Active Writers queue that overlap the head request, the head request is dequeued from the I/O Waiters queue, the virtual cache window is converted to a physical cache window (assuming the heath index has been exceeded), and the head read request is processed. However, if the I/O range of the head read request does not overlap with a completed write request or if there are other I/O requests in the Active Writers queue, then: for each remaining I/O request in the I/O Waiters queue that is a read request and overlaps the write request that just completed, if there are no other I/O requests on the Active Writers queue with an I/O range that overlaps the current read request, the virtual cache window is converted to a physical cache window (assuming the heath index has been exceeded), and the read request is processed. The loop of processing each remaining I/O request in the I/O waiters queue terminates at this point in time.

Also, in this example, processing after a write request for a physical cache window has completed is performed in the following manner If there is no corresponding entry for the write request in the Active Writers queue, no further processing is performed.

However, if there is a corresponding entry for the write request in the Active Writers queue, then the corresponding entry is removed from the queue. Additionally, if the I/O Waiters queue is not empty, then each request in the I/O Waiters queue is processed. Write requests are processed directly. For each read request in the I/O Waiters queue, if it overlaps with the write request that just completed, and if there are no other I/O requests on the Active Writers queue that overlap the current read request, then the read request is dequeued and the request is processed.

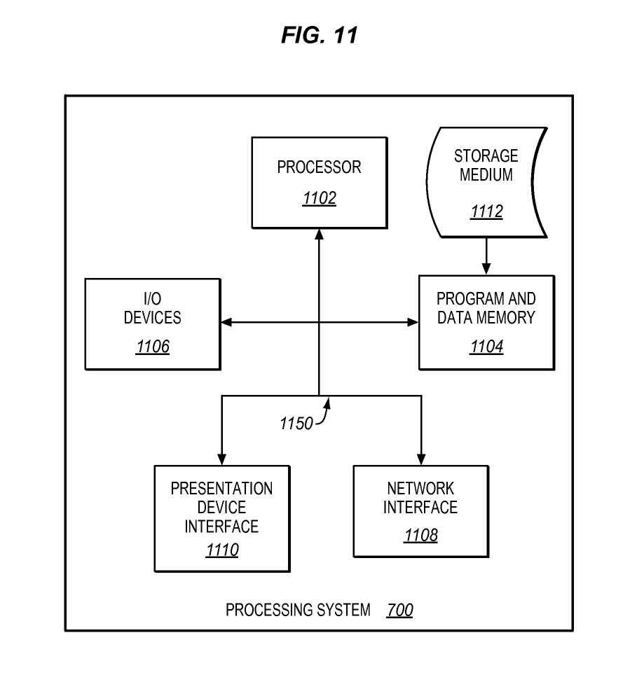

Embodiments disclosed herein can take the form of software, hardware, firmware, or various combinations thereof. In one particular embodiment, software is used to direct a processing system of storage system 100 to perform the various operations disclosed herein. FIG. 11 illustrates an exemplary processing system 1100 operable to execute a computer readable medium embodying programmed instructions. Processing system 1100 is operable to perform the above operations by executing programmed instructions tangibly embodied on computer readable storage medium 1112. In this regard, embodiments of the invention can take the form of a computer program accessible via computer readable medium 1112 providing program code for use by a computer (e.g., processing system 1100) or any other instruction execution system. For the purposes of this description, computer readable storage medium 1112 can be anything that can contain or store the program for use by the computer (e.g., processing system 1100).

Computer readable storage medium 1112 can be an electronic, magnetic, optical, electromagnetic, infrared, or semiconductor device. Examples of computer readable storage medium 1112 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 1100, being suitable for storing and/or executing the program code, includes at least one processor 1102 coupled to program and data memory 1104 through a system bus 1150. Program and data memory 1104 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 1106 (including but not limited to keyboards, displays, pointing devices, etc.) can be coupled either directly or through intervening I/O controllers. Network adapter interfaces 1108 may also be integrated with the system to enable processing system 1100 to become coupled to other data processing systems or storage devices through intervening private or public networks. Modems, cable modems, IBM Channel attachments, SCSI, Fibre Channel, and Ethernet cards are just a few of the currently available types of network or host interface adapters. Presentation device interface 1110 may be integrated with the system to interface to one or more presentation devices, such as printing systems and displays for presentation of presentation data generated by processor 1102.

What is claimed is:

1. A system comprising:
a memory storing entries of cache data for a logical volume; and
a cache manager operable to track usage of the logical volume by a host, to identify logical block addresses of the logical volume to cache based on the tracked usage, to determine that one or more write operations are directed to the identified logical block addresses, to prevent caching for the identified logical block addresses until the write operations have completed, and to populate a new cache entry in the memory with data from the identified logical block addresses responsive to detecting completion of the write operations.

2. The system of claim 1, wherein:
each cache entry is a cache window comprising cache lines that correspond to ranges of logical block addresses, and
the cache manager is further operable, for each cache line, to determine that one or more pending write operations are directed to logical block addresses for the cache line, to pause until the pending write operations have completed, and to populate the cache line with data from logical block addresses for the cache line responsive to detecting completion of the pending write operations.

3. The system of claim 2, wherein:
each range of logical block addresses for a cache line in a cache window is contiguous with another range of logical block addresses for another cache line of the cache window.

4. The system of claim 1, wherein:
the cache manager is further operable to start populating the new cache entry with data prior to the write operations, to detect the write operations while populating the new cache entry, and to halt caching for the new cache entry responsive to detecting the write operations.

5. The system of claim 1, wherein:
the cache manager is further operable to store a count of cache misses for logical block addresses over a period of time, and to identify the logical block addresses by determining which logical block addresses have the highest counts of cache misses.

6. The system of claim 1, wherein:
the cache manager is further operable to correlate write requests with cache entries by determining which write requests share logical block addresses with cache entries.

7. The system of claim 1, wherein:
the cache manager is further operable to populate the cache entries using a read-fill technique, by copying data from the logical volume to the cache entry whenever a read request is received for data that is not yet included within the cache entry.

8. A method comprising:
maintaining entries of cache data for a logical volume;
tracking usage of the logical volume by a host;
identifying logical block addresses of the logical volume to cache based on the tracked usage;
determining that one or more write operations are directed to the identified logical block addresses;
preventing caching for the identified logical block addresses until the write operations have completed; and
populating a new cache entry in memory with data from the identified logical block addresses responsive to detecting completion of the write operations.

9. The method of claim 8, wherein:
each cache entry is a cache window comprising cache lines that correspond to ranges of logical block addresses, and the method further comprises, for each cache line:
determining that one or more pending write operations are directed to logical block addresses for the cache line;
pausing until the pending write operations have completed; and
populating the cache line with data from logical block addresses for the cache line responsive to detecting completion of the pending write operations.

10. The method of claim 9, wherein:
each range of logical block addresses for a cache line in a cache window is contiguous with another range of logical block addresses for another cache line of the cache window.

11. The method of claim 8, further comprising:
starting to populate the new cache entry with data prior to the write operations;
detecting the write operations while populating the new cache entry; and
halting caching for the new cache entry responsive to detecting the write operations.

12. The method of claim 8, further comprising:
storing a count of cache misses for logical block addresses over a period of time; and
identifying the logical block addresses by determining which logical block addresses have the highest counts of cache misses.

13. The method of claim 8, further comprising:
correlating write requests with cache entries by determining which write requests share logical block addresses with cache entries.

14. The method of claim 8, further comprising:
populating the cache entries using a read-fill technique, by copying data from the logical volume to the cache entry whenever a read request is received for data that is not yet included within the cache entry.

15. A non-transitory computer readable medium embodying programmed instructions which, when executed by a processor, are operable for performing a method comprising:
maintaining entries of cache data for a logical volume;
tracking usage of the logical volume by a host;
identifying logical block addresses of the logical volume to cache based on the tracked usage;
determining that one or more write operations are directed to the identified logical block addresses;
preventing caching for the identified logical block addresses until the write operations have completed; and
populating a new cache entry in memory with data from the identified logical block addresses responsive to detecting completion of the write operations.

16. The medium of claim 15, wherein:
each cache entry is a cache window comprising cache lines that correspond to ranges of logical block addresses, and the method further comprises, for each cache line:
determining that one or more pending write operations are directed to logical block addresses for the cache line;
pausing until the pending write operations have completed; and
populating the cache line with data from logical block addresses for the cache line responsive to detecting completion of the pending write operations.

17. The medium of claim 16, wherein:
each range of logical block addresses for a cache line in a cache window is contiguous with another range of logical block addresses for another cache line of the cache window.

18. The medium of claim 15, wherein the method further comprises:
starting to populate the new cache entry with data prior to the write operations;
detecting the write operations while populating the new cache entry; and
halting caching for the new cache entry responsive to detecting the write operations.

19. The medium of claim 15, wherein the method further comprises:
storing a count of cache misses for logical block addresses over a period of time; and
identifying the logical block addresses by determining which logical block addresses have the highest counts of cache misses.

20. The medium of claim 15, wherein the method further comprises:
correlating write requests with cache entries by determining which write requests share logical block addresses with cache entries.
